(19) United States
(12) Patent Application Publication
(10) Pub. No.: US 2009/0033853 A1
(43) Pub. Date: Feb. 5, 2009

(54) Liquid crystal display comprising improved switching means at the display periphery

(76) Inventors: Zaccharia Zenati, Bobigny (FR); Jacques Angele, Malakoff (FR); Nicolas Bollenbach, Le Chesnay (FR); Sylvain Lallemant, Paris (FR); Bertrand Pecout, Guyancourt (FR)

Correspondence Address: Eric S. Hyman;Blakely Sokoloff Taylor & Zafman, 12400 Wilshire Boulevard 7th floor, Los Angeles, CA, 90025, US

(21) Appl. No.: 11/660,389

(22) PCT Filed: Aug. 10, 2005
(86) PCT No.: PCT/FR05/02064

§ 371 Date: Feb. 13, 2007

(30) Foreign Application Priority Data
Aug. 17, 2004 (FR) 0408922

(51) Int. Cl. G02F 1/1337

(52) U.S. Cl. 349/123

(57) ABSTRACT

The invention concerns a liquid crystal display comprising two substrates (10, 20) provided with respective electrodes (12, 22), and located on either side of a layer of liquid crystal molecules (30), the electrodes arranged on one at least of the two substrates (10, 20) being coated with an anchoring layer (14, 24) defining a slight zenithal anchoring enabling the anchor to be ruptured and two textures of liquid crystal molecules whose difference in twisting is of the order of +/−180° to be switched, by hydrodynamic coupling between both substrates. The invention is characterized in that it comprises on at least one of the two substrates (10, 20) patterns (120) which have at least one thickness at least substantially identical to that of the electrodes (12, 22) and which have adhesion properties relative to said anchoring layer (14,24) substantially identical to those of the electrodes (12, 22), said patterns (120) not participating in addressing the display, and located in the non-active zone thereof (62), adjacent an active zone (64) at least on both sides of an active zone (64) perpendicular to the brushing direction (40) and to the direction of the hydrodynamic flux, which is parallel to the brushing di-reaction.

### TECHNICAL DOMAIN

This present invention concerns the area of liquid crystal displays.

More precisely, this present invention concerns bistable displays with nematic liquid crystals. This present invention applies in particular to bistable displays with nematic liquid crystals, and with a shear break condition in which two stable textures differ by a twist of about 180°.

### OBJECTIVE OF THE INVENTION

The objective of this present invention is to improve the performance of bistable display devices. In particular the invention has as its objective to improve the switching of state at the edges of the display area of the display, called the “active zone”, by the use of new techniques.

### Previous Designs

### Conventional LCD Displays

The most commonly-used liquid crystal displays employ a liquid crystal of the nematic type. These are composed of two glass substrates on which a conducting electrode, and then an alignment layer, are deposited. Between the two substrates, a liquid crystal layer is injected. The thickness of the cell is held constant by means of balls distributed over all of the cell, whose diameter is equal to the desired thickness (typically 2 to 6 μm).

Most of the liquid-crystal-based devices proposed and created at present are monostable. In the absence of an electric field, a single texture is created in the device. This corresponds to an absolute minimum of the total energy of the cell. In an electric field, this texture is deformed continuously, and its optical properties vary as a function of the voltage applied. On switching off the field, the nematic again returns to the monostable texture only. Among these systems, the professional engineer will recognise the most widespread operating modes of the nematic displays, namely twisted nematics (TN), super-twisted nematics (STN), electrically controlled birefringence (ECB), vertically aligned nematics (VAN), etc. As far as addressing is concerned, these displays can be addressed directly (very low resolution), in multiplex mode (medium resolution) or in active mode (high resolution).

### State of the BiNem Technology

A new generation of nematic displays, known as “bistables”, has appeared over the last few years. These operate by switching between two stable states in the absence of an electric field. The external electric field is applied only for the time necessary to cause the texture of the liquid crystal to switch from one state to the other. In the absence of an electrical control signal, the display remains in the state it has reached. By its operating principle, this type of display consumes energy in proportion to the number of image changes. Thus, when their frequency reduces, the power necessary to operate the display tends toward zero.

### Principle of Operation

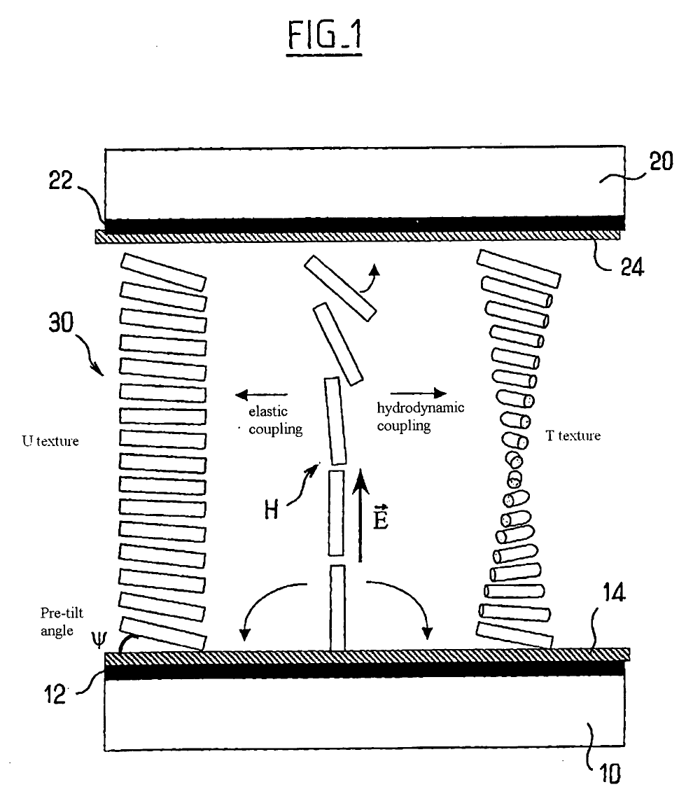

The BINEM® bistable display (documents [1], [2] and [3]) is presented schematically in FIG. 1. It uses two textures, one being a uniform or slightly twisted one U (illustrated on the left of FIG. 1), in which the molecules are more or less parallel to each other, and the other T (illustrated on the right of FIG. 1) which differs from the first in having a twist of about ±1800. The liquid crystal layer 30 is placed between 2 substrates 10, 20, namely the master plate 20, which includes an alignment layer 24 that provides strong anchoring of the liquid crystal, and a “pre-tilt” layer, pre-tilted in relation to the surface of the substrate, with a conventional value of around 5°, and a slave plate 10, which includes an alignment layer 14 that provides a weak anchoring of the liquid crystal and a very weak “pre-tilt” φ (where φ<<1° [4]). The two pre-tilts are in the same direction, meaning that the liquid crystal molecules remain tilted with the same tilt sign over the whole thickness of the cell. Transparent electrodes 12, 22 deposited on the two plates or substrates 10, 20 are used to apply an electric field perpendicular to the substrates.

The textures U and T are optically different, and a BiNem cell placed between crossed or parallel polarisers allows a modulation of the light between black (off state) and white (on state).

The nematic is chiralised with a spontaneous pitch p₀, chosen close to four times the thickness d of the cell, in order to equalise the energies of the two aforementioned textures. The ratio between the thickness d of the cell and the spontaneous pitch p₀, namely d/p₀, is therefore about equal to 0.25±0.1. Without a field, these are the minimum energy states, and the cell is bistable.

In a strong electric field, an almost homeotropic texture, labelled H and illustrated in the centre of FIG. 1, is created. On the slave surface 10, the molecules are normal to the plate in the vicinity of its surface, and the anchoring is said to be “broken”. On switching off the electric field, the cell migrates toward one or other of the bistable textures U or T (see FIG. 1). When the control signals employed induce a strong flow of the liquid crystal in the vicinity of the master plate 20, the hydrodynamic coupling between the master plate 20 and the slave plate 10 brings about the T texture. Otherwise, the U texture is obtained by elastic coupling, assisted by any tilt of the weak anchoring.

In what follows, the “switching” of a BiNem screen element refers to the liquid crystal molecules passing from the homeotropic state H (shear break), and then migrating toward one of the two bistable textures U or T, or a combination of the two textures, on switching off the electric field.

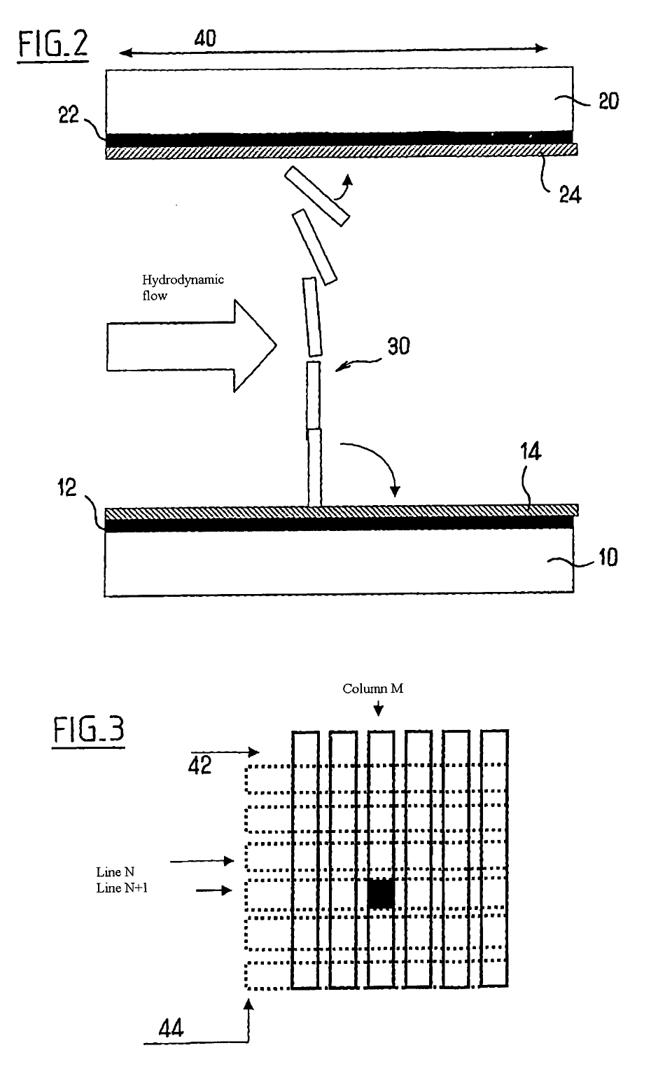

The hydrodynamic coupling 5 between slave plate 10 and master plate 20 is associated with the viscosity of the liquid crystal. On switching off the field, the return to equilibrium of the molecules anchored to the master plate 20 creates a flow close to the latter. The viscosity causes this flow to diffuse throughout the thickness of the cell in less than one microsecond. If the flow is strong enough close to the slave plate 10, it tilts the molecules in the direction which induces the T texture. The molecules rotate in the opposite direction on the two plates 10, 20. The return to equilibrium of the molecules close to the slave plate 10 is a second engine of the flow process, in that it reinforces the latter, and assists with the homogeneous passage of the pixel to the T texture. Thus the passage from the H texture in the field to the T texture is achieved due to a flow and therefore a movement of the liquid crystal in the direction in which the anchoring of the molecules on the master plate 20 is tilted (see FIG. 2). This direction is parallel to the rubbing direction, which is referenced as 40 in FIG. 2.

The elastic coupling between the two plates 10, 20 results in a very slight tilt of the molecules close to the slave plate 10, in the H texture in a field, even if the applied field tends to orient them perpendicularly to the plates 10, 20. In fact, the strong anchoring tilt of the master plate 20 maintains the tilt of the adjacent molecules. The tilt close to the master plate 20 is transmitted by the orientation elasticity of the liquid crystal up to the slave plate 10. On the latter, the force of the anchoring, and any tilt of the latter, amplifies the tilt of the molecules [6]. When the hydrodynamic coupling is insufficient, on switching off the field, to resist the residual tilt of the molecules close to the slave plate 10, then the molecules close to the two plates 10, 20 return to equilibrium by rotating in the same direction, when the U texture is obtained. These two rotations are simultaneous. They induce flows in the opposite direction, which oppose each other. The total flow is zero. There is therefore no overall movement of the liquid crystal during the passage from the H texture to the U texture.

The switching to U or to T of the pixel is therefore directly a function of the intensity or magnitude of the hydrodynamic flow in the vicinity of the master plate 20. In order to obtain a large hydrodynamic flow that brings about the T texture, it is necessary to apply a pulse of an electric field with a steep trailing edge, such as a signal of the slotted or square-wave type. In order to obtain the U texture, a pulse of an electric field with a slow trailing edge, generating a very weak hydrodynamic flow, is necessary, achieved, for example, by a gradual fall-off or one in successive steps [7], [8].

Another important parameter for the switching of a BiNem cell is the value of the pre-tilt φ. Document [4] indicates that it must be very weak (much less than 1°). It must also remain between two values φ1 and φ2 so that the two switching actions to U and to T can take place. If φ<φ1, then switching to U becomes difficult and then impossible, and if φ>φ2, then switching to T becomes difficult and then impossible. The range of values of φ in which window ΔΦ=φ2−φ1, at which the two switching actions can take place is reduced, is typically of the order of 0.50. This high sensitivity to the value of the pre-tilt is specific to the operation of a BiNem cell. The conventional methods, such as TN and STN, for example, which employ strong anchoring, do not exhibit this behaviour.

### Addressing

The 3 addressing modes developed for the standard liquid crystals can be employed for the BiNem display. The most common addressing mode for the BiNem display is multiplex addressing. This is simple, since it includes no active element and, due to the bistable nature of the display, it can be used to address up to a large number of lines. In this mode, the BiNem display is a matrix screen formed of n×m picture elements called pixels, created at the intersection of perpendicular conducting strips deposited respectively on the master 20 and slave 10 substrates (see FIG. 3). The zone located between two adjacent conducting strips carried by a given substrate is called the interpixel space. Outside the display area or active zone formed by all of the addressed pixels, these conducting strips convert into tracks which make the connection to the control circuits, called drivers, located, for example, on flexible connection elements welded to the screen. In FIG. 3, 42 refers to the column electrodes placed on a first substrate, the top substrate 20 for example, and 44 refers to the line electrodes placed on the second substrate, on the bottom slave substrate 10 for example. To display the pixel at coordinates N, M, a column signal is applied to column M and a line signal to line N.

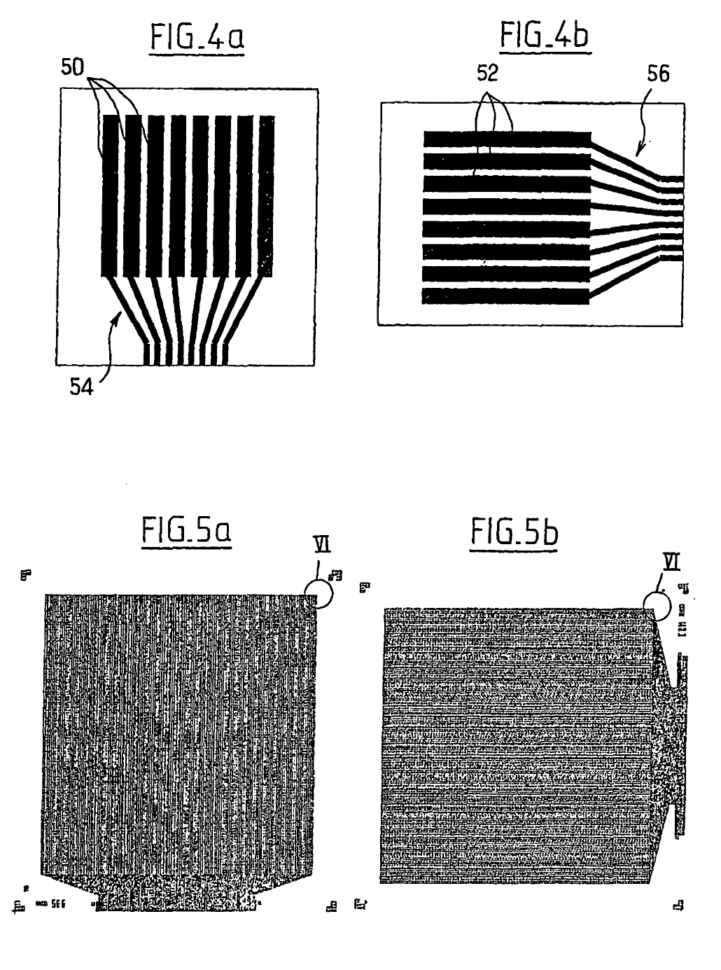

A diagrammatic representation of the design of known electrodes formed on the two glass substrates 10, 20 of a conventional display conforming to previous designs is illustrated in FIG. 4. In general, the conducting electrodes are created with a transparent conductor called ITO (an Indium Tin Oxide mixture). However, when the display is reflective, the electrodes located on the opposite side to the observer do not have the transparency constraint, and can be created with an opaque conducting material such as aluminium. A thin electrode layer is deposited on the two glass substrates 10, and then etched according to the design sought for the electrodes. FIG. 4a illustrates the mask used to etch the so-called upper plate 20, the columns in our example. FIG. 4b illustrates the mask used to etch the electrodes on the so-called bottom plate 10, the lines in our example. In FIGS. 4a and 4b, 50, 52 refer to the strips of column and line electrodes used or addressing the used zone, and 54, 56 refer to the tracks used for the connection of the aforementioned strips to the drivers.

In what follows, we choose to use an ITO electrode, but this example is in no way limiting in respect of the material of which the electrode is composed. An example of a mask representing the structure of the transparent electrodes in ITO of a multiplex BiNem screen according to previous design is provided in FIG. 5. FIG. 5a illustrates the mask of the top plate 20, which in our example are the columns, and FIG. 5b the mask of the bottom plate 10, which in our example are the lines.

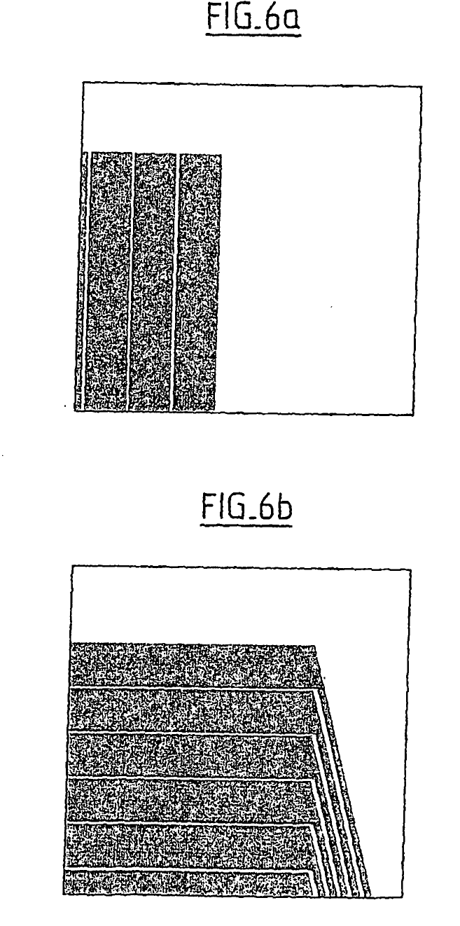

The actual dimensions of the display can vary over a wide range. In the example of FIG. 5, the display has an active zone of 160×160 square pixels measuring 350 μm×350 μm making an active zone of 56 mm×56 mm, with an interpixel space of 10 μm. Due to the very small size of the pixels, the structure of the ITO is not visible at this scale. An enlargement of one edge of the active zone, referenced VI in FIG. 5, is provided in FIG. 6. FIG. 6a illustrates the mask of the top plate 20, which in our example are the columns, and FIG. 6b the mask of the bottom plate 10, which in our example are the lines. The two zones illustrated in FIGS. 6a and 6b are superimposed during the assembly and sealing of the cell.

The zone outside the active zone is called the non-active zone.

### Limitations of the BiNem Displays Created According to Previous Design: “the Periphery Effect”

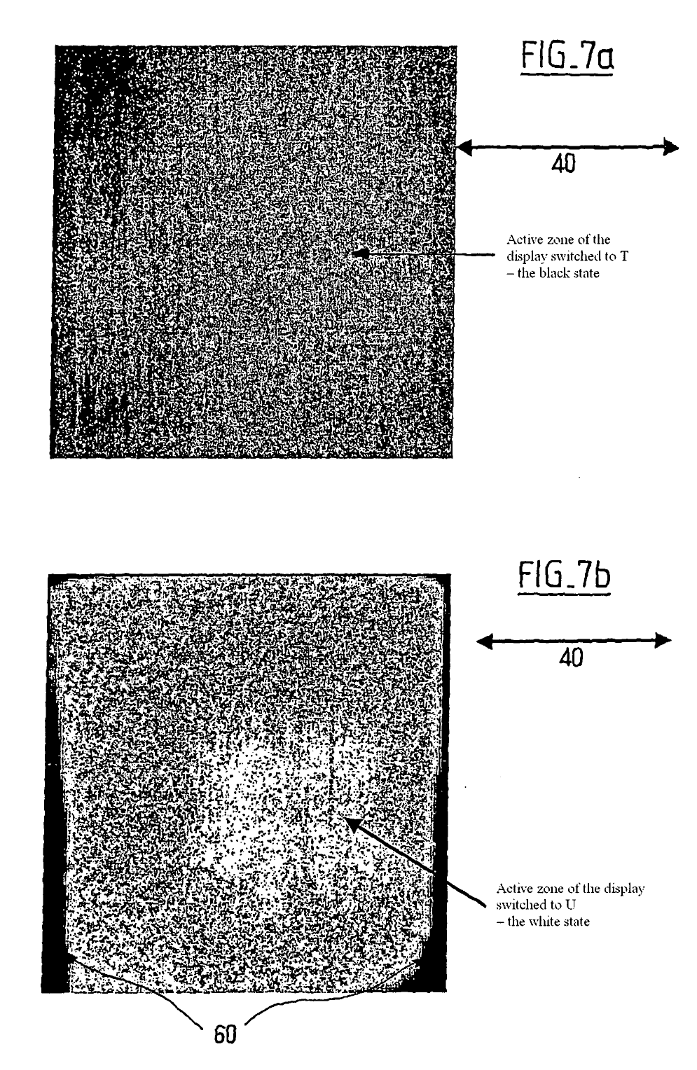

When one addresses a BiNem screen created according to previous design, with the design of the ITO described in the preceding paragraph, it is sometimes observed that there are problems switching to the U texture at the edges of the active zone. FIG. 7 illustrates these switching faults. The active zone of a BiNem display created according to the mask of FIG. 5 is represented in FIG. 7. When the display is mounted in transmissive mode, the T texture corresponds to the off or black state, while the U texture corresponds to the on or white state. All of the cell first receives an electrical signal by multiplexing (as described in document [7]) designed to switch the T pixels that is to the off or black state (FIG. 7a). And then all of the cell receives an electrical signal by multiplexing (as described in document [7]) designed to switch the U pixels that is to the on or white state (FIG. 7b). In FIG. 7b, one observes at the edges of the active zone some areas that remain black, meaning zones where the U-switching does not occur, and these zones remain in the T texture (the off or black state). These zones are known as disturbed states. They are referenced 60 in FIG. 7b. In FIGS. 7a and 7b, 40 refers to the rubbing direction and that of the hydrodynamic flow.

The U switching has not been effected for these pixels located in the disturbed zones 60. The disturbed zones 60 in FIG. 7 thus demonstrate a difference of behaviour at the switching level in relation to the remainder of the cell. Other BiNem cells, created in slightly different conditions, show the same fault but for the T switching.

This type of fault, corresponding to a failure to switch to one of the textures at the edge of the active zone, is called “the periphery effect”.

### The Origin of the Periphery Effect

The analyses conducted by the inventors tend to explain this “periphery effect” as follows:

The “periphery effect” is a U or T switching problem located at the edges of the active zone, over a distance of a few millimetres.

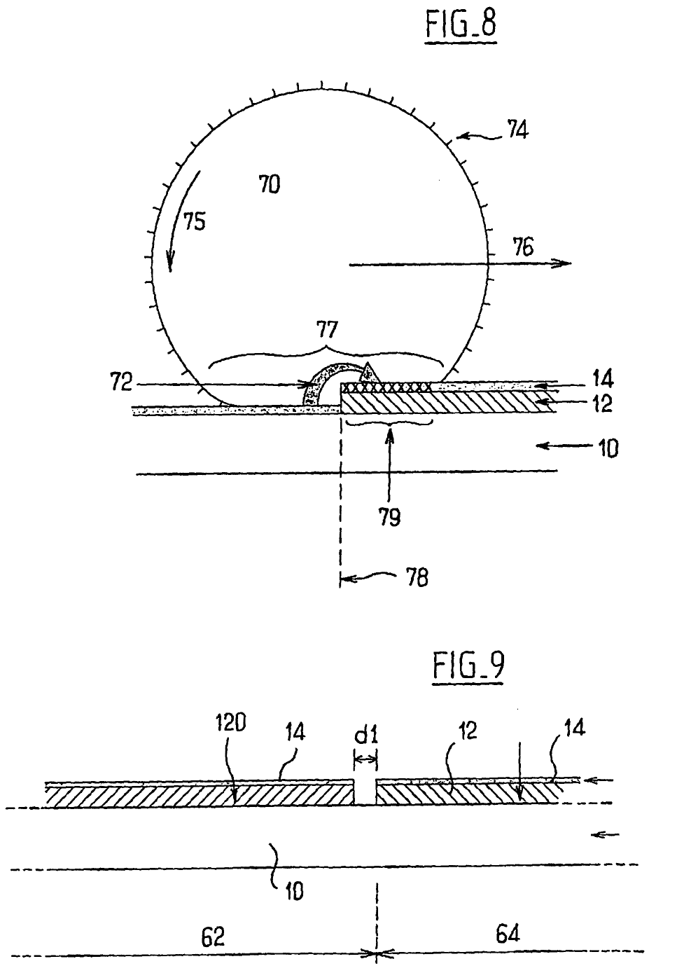

The edges of the active zone correspond to the location of the junction between the zone of the substrate on which ITO (rough) has been deposited for the formation of electrodes, and that where the glass of the substrate is lacking in ITO. The material used to create the weak anchoring layer 14, which totally covers the substrate 10, electrodes 12 included, can be that described in document [9] for example. Once deposited, it is relatively soft in relation to the layers of the polyimide type conventionally used for the strong anchoring layers. When the rubbing roller 70, whose contact area with the substrate is about ten or so millimetres, arrives at the junction of the glass (non-active zone) and the ITO (edge of the active zone), it first rests on the material 14 deposited on the smooth glass 10. The adhesion of this material 14 to the smooth glass 10 is not as strong as to the ITO 12, and the roller 70 moves, “chases” part of the deposited material 14 from the glass 10 to the ITO layer 12 marking the start of the active zone (this movement of material 14, by the roller 70 is shown as 72 in FIG. 8), creating a disturbance of the rubbing action locally at this location, and therefore of the anchoring properties of the material. Since the switching of the BiNem is very sensitive to the value of the pre-tilt on the weak anchoring layer 14 (window Δφ), then U or T switching can be rendered difficult or even impossible in the disturbed zone. With the roller moving by about 1 mm per revolution, the disturbed zone is a few millimetres in the direction of the rubbing action.

In FIG. 8, 74 refers to the hairs of the roller, 75 is the direction of rotation of the roller, 76 is the direction of movement of the roller, 77 is the crushing area of the roller, 78 is the start of the active zone created by an ITO layer 12, and 79 is the disturbed zone.

When the roller 70 arrives at the ITO—glass interface on the other side of the cell, the reasoning is the same except that the material “chased” by the poor adhesion to the glass does a turn on the roller 70 before being re-deposited on the ITO layer 12. With the roller 70 moving by about 1 mm per rotation, a few millimetres of the active zone will also be disturbed.

In FIG. 7, it can be seen that the disturbed zone 60 corresponds closely to the edges of the active zone which lies perpendicularly to the rubbing direction 40 (a few millimetres at each edge).

This very high sensitivity to the rubbing conditions, which is associated with the narrow window, Δφ for the pre-tilt value φ on the weak anchoring layer 14, is specific to the switching mode of the bistable display at the shear break. This does not exist for standard liquid crystal displays of the TN or STN type for example.

### DESCRIPTION OF THE INVENTION

In order to overcome the drawbacks inherent in the previous designs, such as the “the periphery effect”, this present invention proposes a liquid crystal display device with two substrates, respectively equipped with electrodes and located on either side of a layer of liquid crystal molecules, with the electrodes provided on at least one of the two substrates being covered with an anchoring layer that determines a weak zenithal anchoring that allows a shear break to occur, and switching between two textures of liquid crystal molecules whose twist differs by some ±180°, by hydrodynamic coupling between the two substrates, characterised by the fact that it includes patterns, on at least one of the two substrates, which have a thickness that is at least approximately the same as that of the electrodes, and which has adhesion characteristics, in relation to the said anchoring layer, that is more or less identical to that of the electrodes, with these patterns not contributing to the addressing of the display, and located in the non-active zone of the latter, alongside a zone that is active at least on the two sides of an active zone perpendicular to the rubbing direction and to the direction of the hydrodynamic flow, which is parallel to the rubbing direction.

According to another advantageous characteristic of this present invention, the aforementioned patterns are composed of the same material as that uses to make up the electrodes of the display.

Thus due to this present invention, the switching between the two textures at the edge of the active zone takes place in the same conditions as the switching between the two textures at the centre of the active zone of the display.

According to one advantageous characteristic of this present invention, the said patterns which do not contribute to the addressing of the display, in the non-active zone, are isolated electrically.

### DETAILED DESCRIPTION OF THE INVENTION

Other characteristics objectives and advantages of this present invention will appear on reading the detailed description that follows, and with reference to the appended drawings, which are provided by way of non-limiting examples and in which:

FIG. 1, described previously, schematically represents the switching principle of a display of the BiNem type,

FIG. 2, described previously, schematically represents a hydrodynamic flow 20 during a sudden cut-off of the electric field in a device of the BiNem type,

FIG. 3, described previously, is a diagrammatic representation of the operation of a conventional matrix screen,

FIGS. 4a and 4b, described previously, are a diagrammatic representation of the design of the known electrodes intended to be formed on the two substrates respectively,

FIGS. 5a and 5b, described previously, show examples of masks for the formation of these electrodes,

FIGS. 6a and 6b, described previously, represent enlarged views of one edge of the masks illustrated in FIGS. 5a and 5b,

FIG. 7, described previously, is a photograph of the active zone of a BiNem display according to previous design. More precisely, FIG. 7a represents the whole of the display in a first, T-switched state (black), while FIG. 7b represents the same display in a second, U-switched state (white),

FIG. 8, described previously, schematically represents the disturbance of the anchoring properties at the edge of the active zone brought about by the rubbing on a weak anchoring layer of a BiNem device,

FIG. 9 schematically represents the principle at the foundation of the invention, which consists of adding patterns to the non-active zone alongside an active zone,

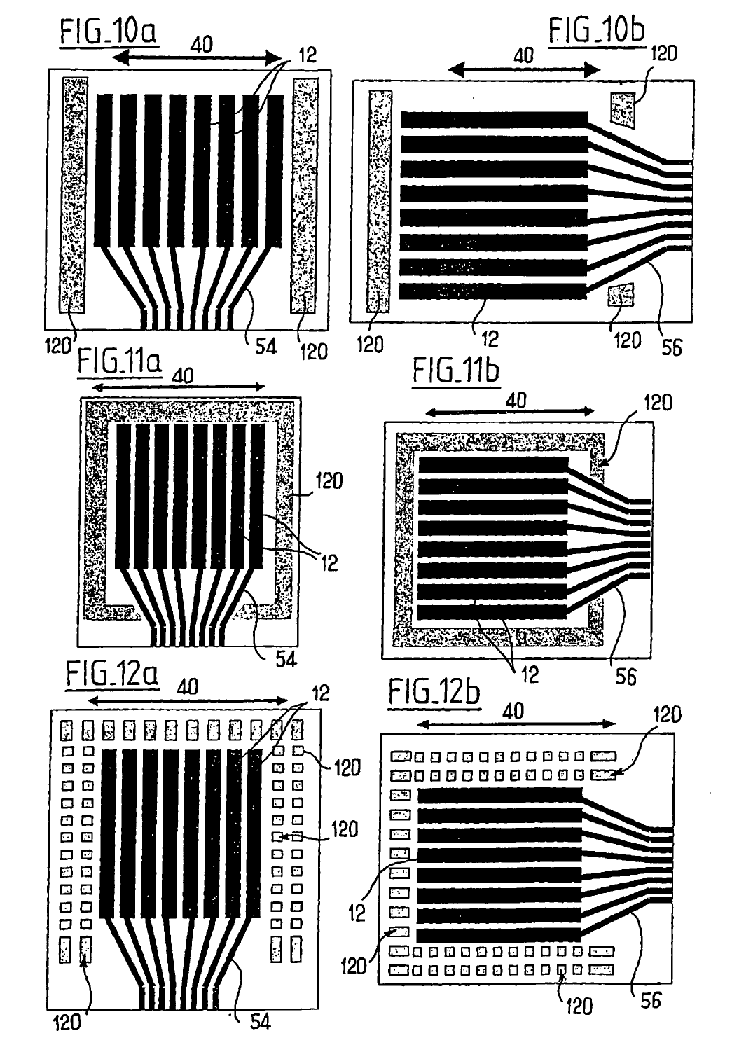

FIG. 10 is a plan view of “neutral” patterns (here they are ITO) in accordance with this present invention, positioned on the two sides of an active zone perpendicular to the rubbing direction, for the two plates of the display in FIGS. 10a and 10b respectively,

FIG. 11 represents a variant of such “neutral” patterns (here they are ITO) in accordance with this present invention, positioned all around the edges of a non-active zone which lies alongside an active zone, for the two plates of the display in FIGS. 11a and 11b respectively,

FIG. 12 represents another variant of “neutral” patterns (here they are ITO) according to the invention broken up into small individual tiles, for the two plates of the display in FIGS. 12a and 12b respectively,

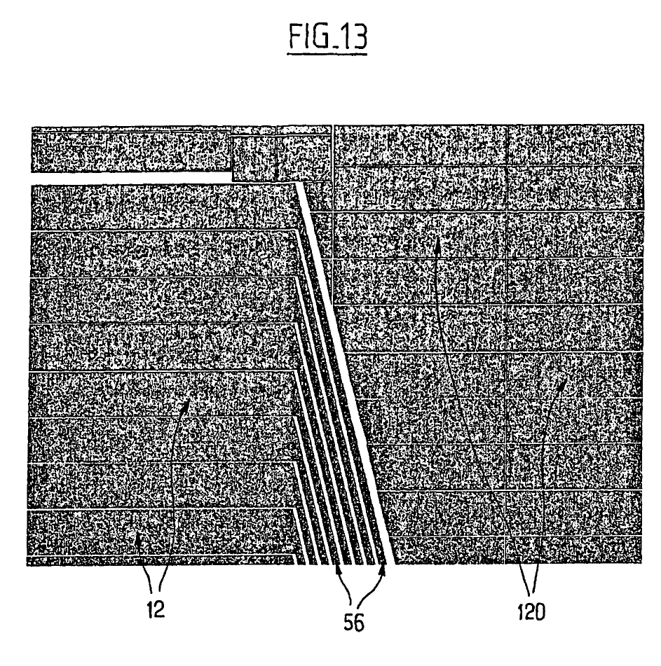

FIG. 13 is an enlarged view of one edge of the active zone of a display plate according to this present invention, and more precisely illustrates a dense tiling of “neutral” patterns (here they are ITO) in a non-active zone alongside the active zone,

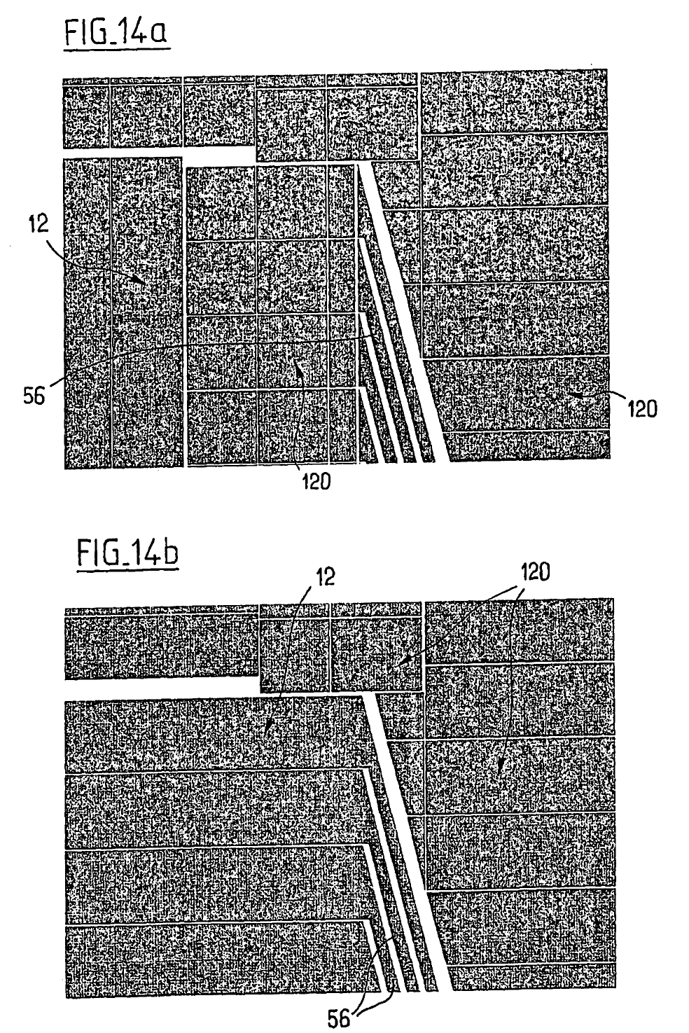

FIG. 14 represents, in FIGS. 14a and 14b respectively, two series of “neutral” patterns (here they are ITO) which are strictly superimposable once the two plates are facing each other for the sealing of the cell, and

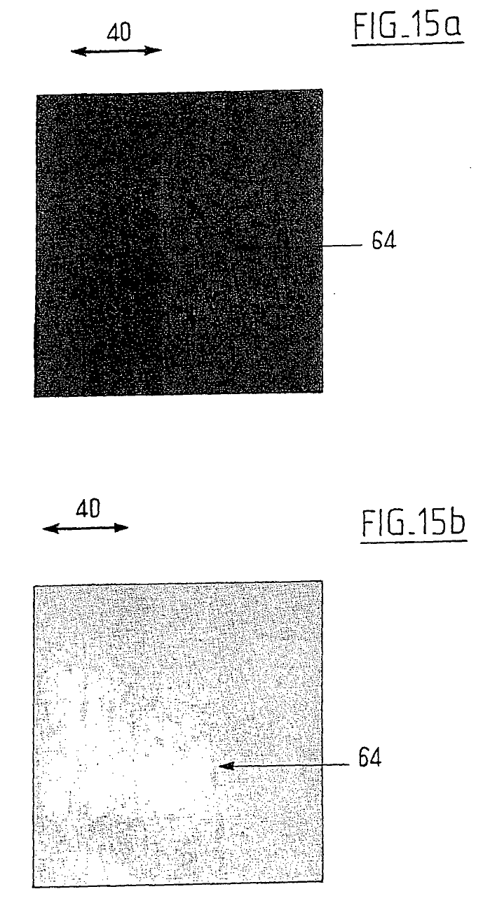

FIG. 15 is a photograph of the active zone of a BiNem display according to this present invention, with FIG. 15a representing the active zone of the display, after which the latter has received an electrical signal intended to switch all of the pixels to the T state (off or black state), while

FIG. 15b represents the same active zone of the display after the latter has received an electrical signal intended to switch it to the U state (On or white state).

The invention will now be explained in greater detail, with reference to FIGS. 9 et seq.

This present invention applies to bistable nematic displays of the BiNem type whose general technology is now known to the professional engineer, and whose general principles have been described above.

In the case of a bistable liquid crystal display according to the invention, the means used to eliminate the disturbing effect of the rubbing at the edge of the active zone consists of adding patterns 120 whose thickness and adhesion characteristics in relation to the low-energy of zenithal anchoring layer 14, are more or less equivalent to those of the electrodes 12, 22 of the display, in the non-active zone which lies alongside the active zone, such as that illustrated in FIG. 9. Typically the thickness of the blocks 120 do not differ by more than 10% of that of the electrodes 12, 22. Thus the top surface of the blocks 120 is at least approximately coplanar with the top surface of the electrodes 12, 22.

In FIG. 9, 120 refers to a pattern according to the invention which is not connected electrically and placed in a non-active zone 62, on the outside the active zone 64 of the display.

The material of the weak anchoring alignment layer 14 is thus deposited in a homogeneous manner, with a good adhesion over all of the patterns, 12 (forming the electrodes in the active zone 64) and 120 located in the non-active zone 62. When the rubbing roller 70 passes from the non-active zone 62 to the active zone 64 and vice versa, the material 14 is not “chased” from the non-active part 64 to the active part 62, and the rubbing parameter forming the pre-tilt is not disturbed.

These patterns 120, added in the context of this present invention, are not connected electrically. They have no vocation to address a liquid crystal zone. They are intended to ensure the continuity of the rubbing parameters at the edge of the active zone 64. These added patterns 120 of the invention are called “neutral” patterns.

In a non-limiting manner, the “neutral” patterns according to the invention can be composed of the same material as that constituting the conducting electrode of the display. This material can be ITO for example, generally used as the transparent electrode in liquid crystal displays.

The “neutral” patterns according to the invention are preferably deposited on the two substrates of the display, so as to ensure good homogeneity of the cell thickness. Where appropriate however, such neutral patterns 120 can be provided on a single substrate, and this is preferably the substrate 10 that carries the anchoring layer 14 forming a weak zenithal anchoring energy.

Several variants are possible at the level of the “neutral” patterns 120 which we will choose for the remainder, composed of ITO by way of an example.

A first variant, illustrated in FIG. 10, consists of positioning the “neutral patterns” 120 of the invention on the two sides of an active zone 64 perpendicular to the rubbing direction 40. FIG. 10a illustrates ITO patterns 120 on the so-called upper plate 20, which in our example are the columns, and FIG. 10b illustrates ITO patterns 120 on the bottom plate 10, which in our example are the lines.

The “periphery effect”, which essentially appears on these two sides, is thus eliminated. However this design is tributary to the rubbing direction 40 of the display.

In order to render the design independent of the rubbing direction 40, a second variant (FIG. 11) proposes to position “neutral ITO patterns” 120 according to the invention all around the edges of the non-active zone 62 lying alongside an active zone 64. FIG. 11a illustrates ITO patterns 120 on the top plate 20, which in our example are the columns, and FIG. 11b illustrates ITO patterns 120 on the bottom plate 10, which in our example are the lines.

In order to avoid short-circuits and field effects, a third variant consists of dividing the ITO “neutral” patterns 120 into small rectangular tiles, for example, or any other appropriate form, rather than using continuous blocks, like that illustrated in FIG. 12. The aforementioned tiles can have shapes that are identical to each other or be of diverse shape. FIG. 12a illustrates ITO patterns 120 on the top plate 20, which in our example are the columns, and FIG. 12b illustrates ITO patterns 120 on the bottom plate 10, which in our example are the lines.

A fourth variant consists of creating a tiling of “neutral” ITO patterns 120 that is as dense as possible in the non-active zone 62 alongside an active zone 64 as illustrated in FIG. 13.

A fifth variant consists of creating, on each plate, patterns 120 that are strictly superimposable once the two plates 10, 20 are opposite to each other for the sealing of the cell. FIG. 14 shows an enlargement of one edge of the active zone of a 160×160 pixel display as described above, integrating the fourth and fifth variants of the invention.

FIG. 14a illustrates ITO patterns 120 on the top plate 20, which in our example are the columns, and FIG. 14b illustrates ITO patterns 120 on the bottom plate 10, which in our example are the lines.

Naturally, all of the combinations of the different variants described above are possible.

FIG. 15 shows the active zone 64 of a 160×160 display according to the invention, which integrates variants 4 and 5 of the invention. The switching takes place in the same conditions as those described in the paragraph entitled “Limitations presented by the BiNem created according to previous design: the periphery effect”. To begin with, all of the display is T-switched (black in FIG. 15a). Then all of the display is U-switched (white in FIG. 15b). It can be seen from FIG. 15b, by comparing it with FIG. 7b, that the “periphery effect” has disappeared, and all of the active zone 64 has switched to the U state (white).

As can be seen in FIGS. 13 and 14, the “neutral” ITO patterns 120 are preferably shaped to fit the contour of the electrodes 12 formed in the active zone 64. In other words, the interval separating the “neutral” ITO patterns 120 and the active electrodes 12 is reduced to the minimum width to ensure the electrical isolation required between these electrically conducting areas.

Preferably, in the context of this present invention, the distance (referenced d1 in FIG. 9) separating the “neutral” ITO patterns 120 and the adjacent active electrodes actives 12 is between 1 and 500 μm, and most preferably between 5 and 50 μm.

Moreover, in the context of this present invention, the distance separating the neutral ITO patterns 120 from each other, is also preferably between 1 and 500 μm, and most preferably between 5 and 50 μm.

Naturally, this present invention is not limited to the particular methods of implementation that have been described above, but also extends to any variant that conforms to its spirit.

For example, this present description of the invention concerns a bistable liquid crystal display device with multiplex passive or direct addressing. But the invention can also be applied to a bistable liquid crystal display device with active addressing using transistors deposited on glass to control the switching of the pixels, as described in document [8] for example.

In the context of this present invention, the two textures, which differ by about 180°, are not necessarily one uniform or slightly twisted (with a twist close to 0°) and the other close to a half turn (with a twist close to 180°). In fact, in the context of this present invention, it is possible to have different twists for these two textures, such as 45° and 225° for example, the important thing being that the twists between the two textures different by an angle of about 180°.

### REFERENCED DOCUMENTS

Doc [1]: FR-A-2 740 893
Doc [2]: FR-A-2 740 894
Doc [3]: US-A-6 327 017
Doc [4]: P. Martinot Lagarde et al., SPIE vol. 5003 (2003), p 25-34
Doc [5]: M. Giocondo, I. Lelidis, I. Dozov, G. Durand, Eur. Phys. J. AP 5, 227 (1999).
Doc [6]: I. Dozov, Ph. Martinot-Lagarde, Phys. Rev. E., 58, 7442 (1998).
Doc [7]: FR-A-2 835 644
Doc [8]: FR-A-2 847 704
Doc [9]: FR-A-2 840 694

1. A liquid crystal display device with two substrates (10, 20) fitted with respective electrodes (12, 22), and located on either side of a layer of liquid crystal molecules (3), where the electrodes provided on at least one of the two substrates (10, 20) are covered with an anchoring layer (14, 24) forming a weak zenithal anchoring effect that allows a shear break to occur, and a switching action between two textures of liquid crystal molecules whose twist differs by about ±180°, by hydrodynamic coupling between the two substrates, characterized by the fact that it includes, on at least one of the two substrates (10, 20), patterns (120) with a thickness that is at least approximately the same as that of the electrodes (12, 22), and which have adhesion characteristics in relation to the said anchoring layer (14, 24) that are more or less identical to those of the electrodes (12, 22), where these patterns (120) do not contribute to the addressing of the display, and are located in the non-active zone (62) of the latter, alongside an active zone (64), at least on the two sides of an active zone (64) perpendicular to the rubbing direction (40) and to the direction of the hydrodynamic flow, which is parallel to the rubbing direction.

2. A device according to claim 1, characterized by the fact that the patterns (120) are composed of the same material as that used to make up the electrodes (12, 22) of the display.

3. A device according to claim 1, characterized by the fact that the patterns (120) are provided on a substrate (10) that has an anchoring layer (14) which creates a weak zenithal anchoring energy.

4. A device according to claim 1, characterized by the fact that the patterns (120) are provided on the two substrates (10, 20).

5. A device according to claim 1, characterized by the fact that it includes, on at least one of the substrates (10, 20), resources for anchoring of the liquid crystal molecules, which allow a shear break to occur on the application of an appropriate electric field between electrodes (12, 22) placed respectively on the substrates (10, 20).

6. A device according to claim 1, characterized by the fact that it includes resources forming two stable states of the liquid crystal molecules in the absence of an electric field.

7. A device according to claim 1, characterized by the fact that it uses two textures of liquid crystal molecules, one which is uniform or slightly twisted, for which the molecules are at least more or less parallel to each other, and the other which differs from the first by a twist of about 180°.

8. A device according to claim 1, characterized by the fact that the ratio between the thickness d of the cell and the spontaneous pitch P₀ of the liquid crystal molecules is about equal to 0.25±0.1.

9. A device according to claim 1, characterized by the fact that the patterns (120) that do not contribute to the addressing of the display are isolated electrically.

10. A device according to claim 1, characterized by the fact that the patterns (120) that do not contribute to the addressing of the display are placed all around the edges of an active zone (64).

11. A device according to claim 1, characterized by the fact that the patterns (120) that do not contribute to the addressing of the display are formed of solid patterns.

12. A device according to claim 1, characterized by the fact that the patterns (120) that do not contribute to the addressing of the display are broken up.

13. A device according to claim 12, characterized by the fact that the distance separating the patterns (120) from each other is between 1 and 55 μm, and most preferably between 5 and 50 μm.

14. A device according to claim 1, characterized by the fact that the patterns (120) that do not contribute to the addressing of the display are formed of tiled patterns.

15. A device according to claim 1, characterized by the fact that the patterns (120) that do not contribute to the addressing of the display are formed at least partially from tiled patterns with a geometry that is mutually more or less identical.

16. A device according to claim 1, characterized by the fact that the patterns (120) that do not contribute to the addressing of the display are formed at least partially of tiled patterns of diverse shape.

17. A device according to claim 1, characterized by the fact that the patterns (120) that do not contribute to the addressing of the display are formed from tiled patterns that are very dense.

18. A device according to claim 1, characterized by the fact that the patterns (120) that do not contribute to the addressing of the display are shaped to fit the contour of the electrodes (12) formed in the active zone (64).

19. A device according to claim 1, characterized by the fact that the interval (d1) separating the patterns (120) that do not contribute to the addressing of the display and the active electrodes (12) is reduced to the minimum width to ensure the required electrical isolation between these electrically conducting areas (20).

20. A device according to claim 1, characterized by the fact that each of the two substrates (10, 20) respectively includes patterns (120) that do not contribute to the addressing of the display, and that are exactly superimposable.

21. (canceled)

22. A device according to claim 1, characterized by the fact that it includes multiplex passive addressing resources.

23. A device according to claim 1, characterized by the fact that it includes direct passive addressing resources.

24. A device according to claim 1, characterized by the fact that it includes active addressing resources.

25. A device according to claim 1, characterized by the fact that the distance (d1) separating the patterns (120) and the adjacent active electrodes actives (12) is between 2 and 500 μm, and most preferably between 5 and 50 μm.

26. A device according to claim 1, characterized by the fact that the top surface of the patterns (120) is at least more or less coplanar with the top surface of the electrodes (12, 22).
